(19) United States
(12) Patent Application Publication
(10) Pub. No.: US 2010/0263798 A1
(43) Pub. Date: Oct. 21, 2010

(54) TRANSFERRING DEVICE FOR LIGHT-REFLECTABLE TAPE

(76) Inventor: Yuh Yi TSAI, Dadu Township (TW)

Correspondence Address: SINORICA, LLC, 2275 Research Blvd., Suite 500, ROCKVILLE, MD, 20850, US

(21) Appl. No.: 12/427,360

(22) Filed: Apr. 21, 2009

(51) Int. Cl. B32B 38/18

(52) U.S. Cl. 156/538

(57) ABSTRACT

A transferring device for light-reflectable tape, comprising a casing and a gear transmission unit, wherein, a sticker tape is winded around a tape roll gear to form a tape roll comprising an adhesive layer and a released paper. The front end of the adhesive layer extends out of the dispensing outlet of the casing, a pressure roller where located at the dispensing outlet of the casing is pressed on the layer to provide a brake force. In addition, the elastic position-limited teeth of the tape roll gear are engaged with a ratchet wheel in order to prevent the loosing of the tape roll gear. When the tape roll is rotating together with the tape roll gear, the driven gear and the released paper rolling wheel will be rotated as well, so that the released paper of the tape roll can be retrieved with the released paper rolling wheel; as for the speed of retrieving is adjustable by adjusting the speed adjusting wheel which sheathed with the released paper rolling wheel, so that the lock of the tape roll gear, driven gear and the released paper rolling wheel can be avoided, and the corrugated mark and the breaking of the adhesive layer will not be happened. Meanwhile, the pressure plate of the casing is used for guiding the tape plastering along the edge of the wheel rim of the tire. Thus, the usage of the light-reflectable tape is more convenient and the shape of the tape can be maintained as well.

### BACKGROUND OF THE INVENTION

1. Field of the Invention

The present invention relates to a transferring device. More particularly, the present invention relates to a device used in transferring of a light-reflectable tape roll.

2. Description of Related Art

A conventional transferring device as shown in FIGS. 7 and 8 comprises a main seat 40 and a rotating seat 50 pivotally mounted on said main seat 40. The main seat 40 comprises tow divided shelves 41 which are in conjunction with a dispensing portion 42 in the front, a first face 420 and a second face 421 are formed on the dispensing portion 42 oppositely, as for a vertical face 422 is formed in the front of said first face 420 and second face 421. A passage 423 is penetrated the first face 420 and second face 421, a tape roll is mounted on the rotating seat 50 which extending a tape 51 through the passage 423 from the first face 420 to the second face 421 toward the vertical face 422, so as the tape 51 can be transferred on a desired object.

However, the conventional transferring device has contained some improvable defects, such as:

1. Poor usage: The tape roll is mounted on the rotating seat 50, and the tape 51 is penetrated the passage 423 from the first face 420 to the second face 421 toward the vertical face 422. However, the tape 51 is easily obstructed at the corner position of the passage 423 during the operation of the device, so the use of the conventional transferring device is poor.

2. Interruption of the tape: The tape roll is mounted on the rotating seat 50, and the tape 51 is penetrated the passage 423 from the first face 420 to the second face 421 toward the vertical face 422. However, the tape 51 is easily obstructed at the corner position of the passage 423 during the operation of the device, if a pulling force is applied to the tape 51, the tape 51 may be broken and lead to cut off the tape 51. In addition, a corrugated mark is easily appeared on the tape 51 when the tape is passed by the corner position of the passage 423, and that causes an unpleased shape of the tape 51.

The present invention is intended to improve the above mentioned drawbacks of the conventional transferring device. The present invention provides improved solutions to the problems of poor usage and Interruption of the tape.

### SUMMARY OF THE INVENTION

The primary purpose for the present invention is to provide a transferring device for a light-reflectable tape, comprising: a casing and a gear transmission unit; wherein, the casing comprises an dispensing outlet, a pressure plate, a first support shaft, a second support shaft and a protruded shaft, two pivot centers are situated at the opposite side of the dispensing outlet provided for a pressure roller to install on the pivot centers pivotally; in addition, a ratchet wheel is installed between the first support shaft and the casing. The gear transmission unit comprises a tape roll gear, a driven gear, a released paper rolling gear and a speed adjusting wheel; wherein, a plurality of elastic position-limited teeth are installed inside of the tape roll gear, and the tape roll gear is mounted on the first support shaft of the casing pivotally; the elastic position-limited teeth are engaged with the ratchet wheel which is installed between the first support shaft and the casing. The driven gear is mounted on the protruded shaft of the casing pivotally, and the released paper rolling gear is sheathed with the speed adjusting wheel and pivotally mounted on second support shaft of the casing. The tape roll gear of the gear transmission unit is meshed with the driven gear, and the driven gear is further meshed with the released paper rolling wheel, so that the rotation is transmitted. A sticker tape is winded around the tape roll gear to form a tape roll comprising an adhesive layer and a released paper. The front end of the adhesive layer extends out of the dispensing outlet of the casing, the pressure roller where located at the dispensing outlet of the casing is pressed on the layer to provide a brake force; in addition, the elastic position-limited teeth of the tape roll gear are engaged with the ratchet wheel in order to prevent the loosing of the tape roll gear. When the tape roll is rotating together with the tape roll gear, the driven gear and the released paper rolling wheel will be rotated as well, so that the released paper of the tape roll can be retrieved with the released paper rolling wheel, as for the speed of retrieving is adjustable by adjusting the speed adjusting wheel which sheathed with the released paper rolling wheel, so that the lock of the tape roll gear, driven gear and the released paper rolling wheel can be avoided, and the corrugated mark and the breaking of the adhesive layer will not be happened. Meanwhile, the pressure plate of the casing is used for guiding the tape plastering along the edge of the wheel rim of the tire. Thus, the usage of the light-reflectable tape is more convenient and the shape of the tape can be maintained as well.

### BRIEF DESCRIPTION OF THE DRAWINGS

FIG. 1 is a perspective view schematically showing the transferring device of the present invention;

FIG. 2 is a segmented view schematically showing the transferring device of the present invention;

FIG. 3 is a cross-sectional view schematically showing the transferring device of the present invention;

FIG. 4 is a cross-sectional view schematically showing the operating movement of the present invention;

FIG. 5 is a cross-sectional view schematically showing the practical use of the present invention;

FIG. 6 is a cross-sectional view schematically showing an another embodiment of the present invention;

FIG. 7 is a cross-sectional view schematically showing the conventional transferring device; and

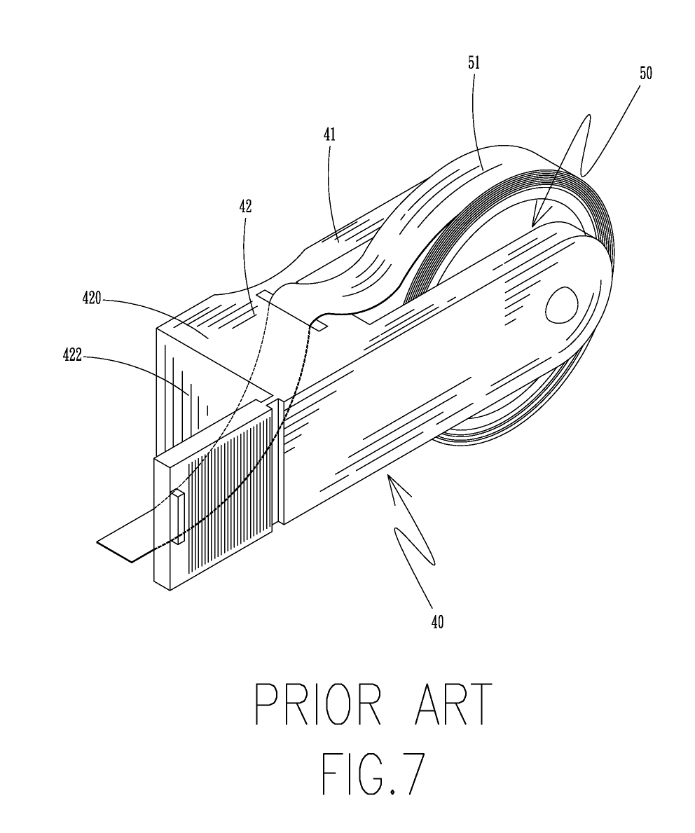

FIG. 8 is a perspective view of the conventional transferring device.

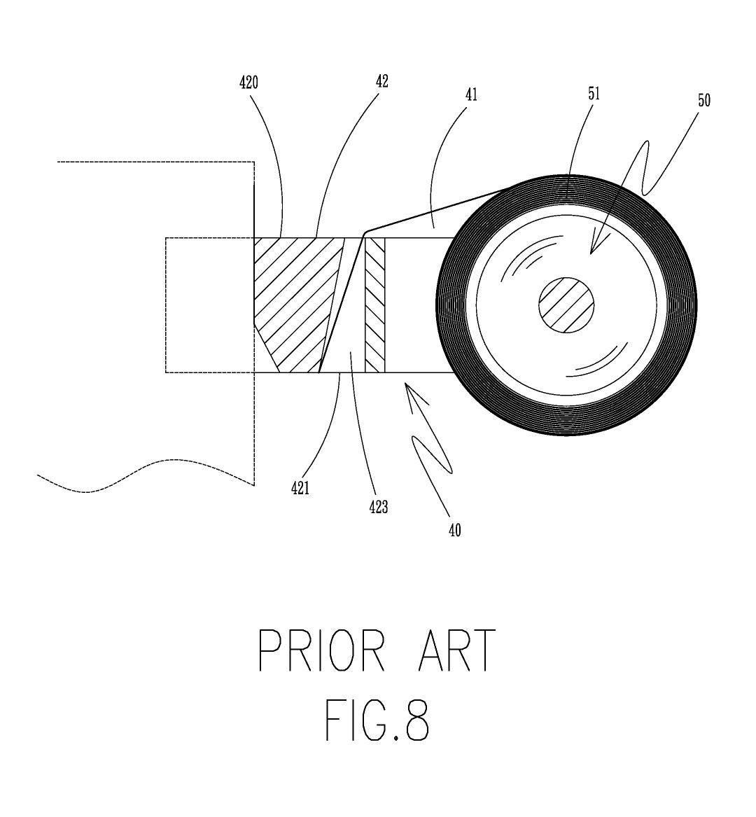

### DETAILED DESCRIPTION OF PREFERRED EMBODIMENT

While this invention is capable of embodiment in many different forms, what is shown in the drawings and described in detail herein is the preferred embodiment of the invention. The preferred embodiment is disclosed with the understanding that the present description is but one example of the principles of the invention and is not intended to limit the broad aspects of the invention to the single embodiment illustrated.

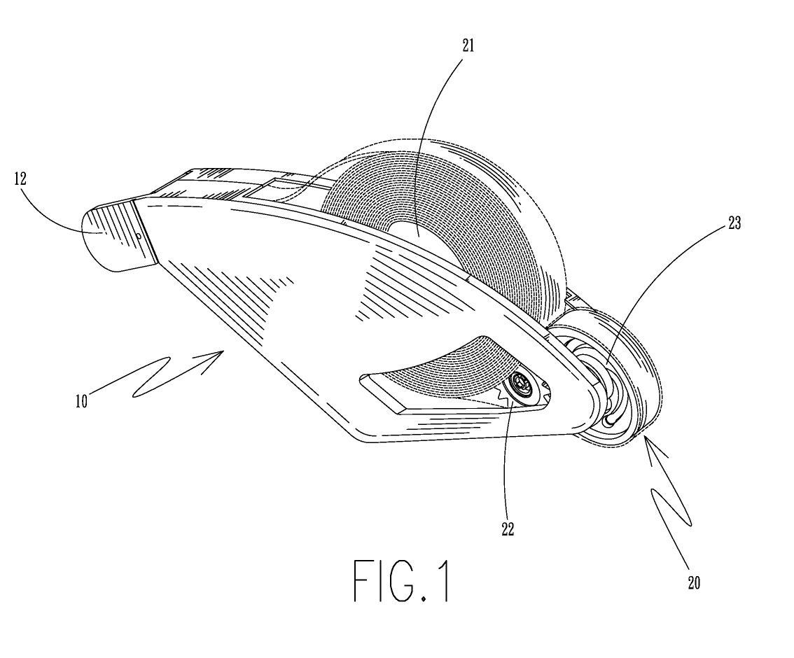

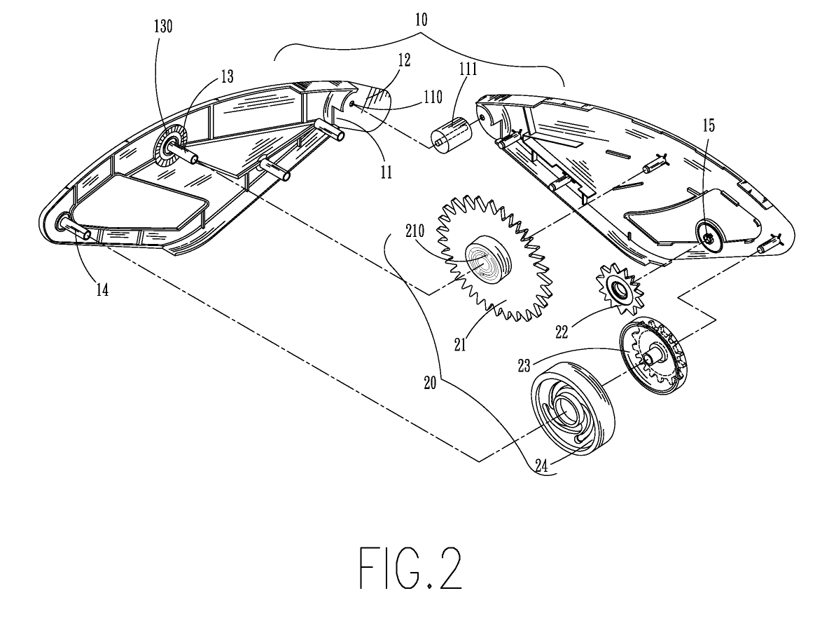

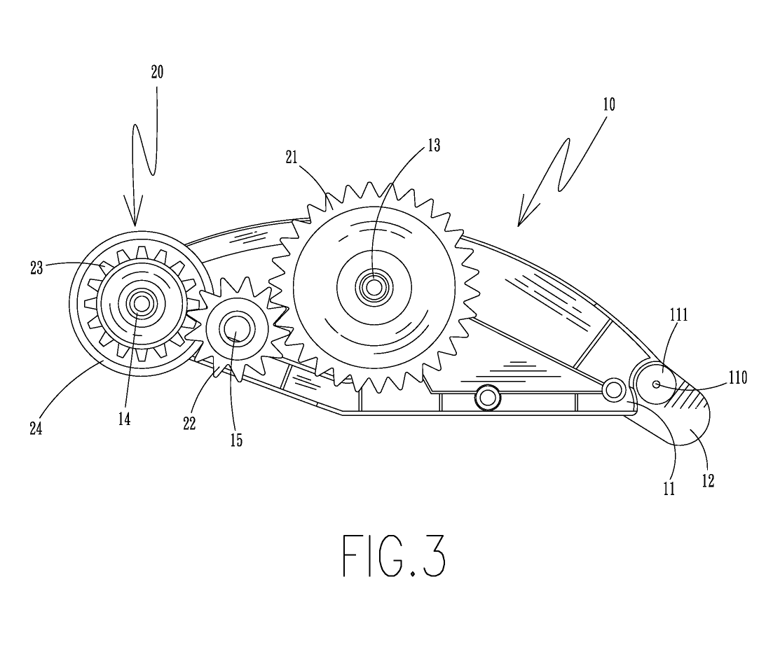

FIGS. 1 to 3 are perspective, segmented and cross-sectional views schematically showing a preferable embodiment of the present invention.

The transferring device comprises:

a casing 10, having an dispensing outlet 11, a pressure plate 12, a first support shaft 13, a second support shaft 14 and a protruded shaft 15; wherein, the pressure plate 12 is situated at the front end of the dispensing outlet 11, and two pivot centers 110 are situated at the opposite side of the dispensing outlet 11 provided for a pressure roller 111 to install on the pivot centers 110 pivotally; in addition, a ratchet wheel 130 is installed between the first support shaft 13 and the casing 10; and

a gear transmission unit 20, comprising a tape roll gear 21, a driven gear 22, a released paper rolling gear 23 and a speed adjusting wheel 24; wherein, a plurality of elastic position-limited teeth 210 are installed inside of the tape roll gear 21, and the tape roll gear 21 is pivotally mounted on the first support shaft 13 of the casing 10; the elastic position-limited teeth 210 are engaged with the ratchet wheel 130 which is installed between the first support shaft 13 and the casing 10. The driven gear 22 is mounted on the protruded shaft 15 of the casing 10 pivotally, and the released paper rolling gear 23 is sheathed with the speed adjusting wheel 24 and pivotally mounted on the second support shaft 14 of the casing 10. The tape roll gear 21 is meshed with the driven gear 22, and the driven gear 22 is further meshed with the released paper rolling wheel 23 to transmit the driving. As for the gear transmission unit 20 is provided in the casing 10.

In light of the structural description stated above, the present invention fulfills a transferring device thereof.

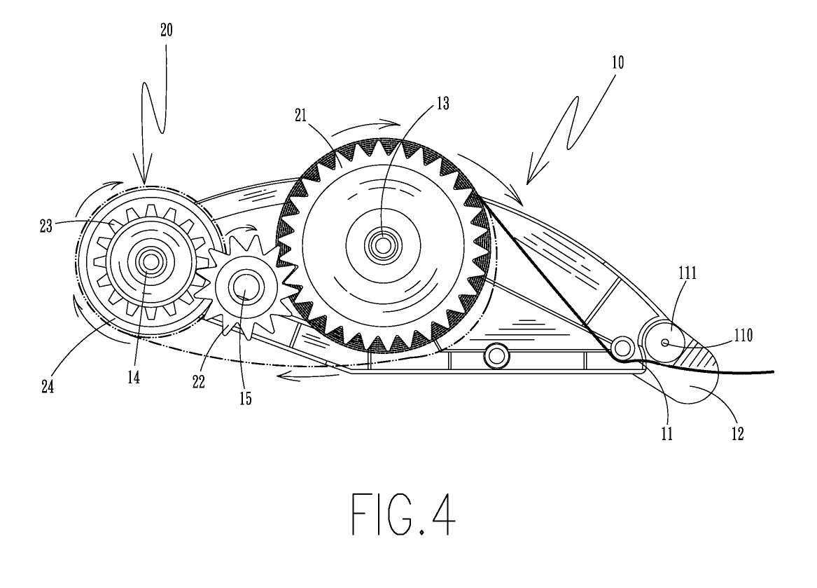

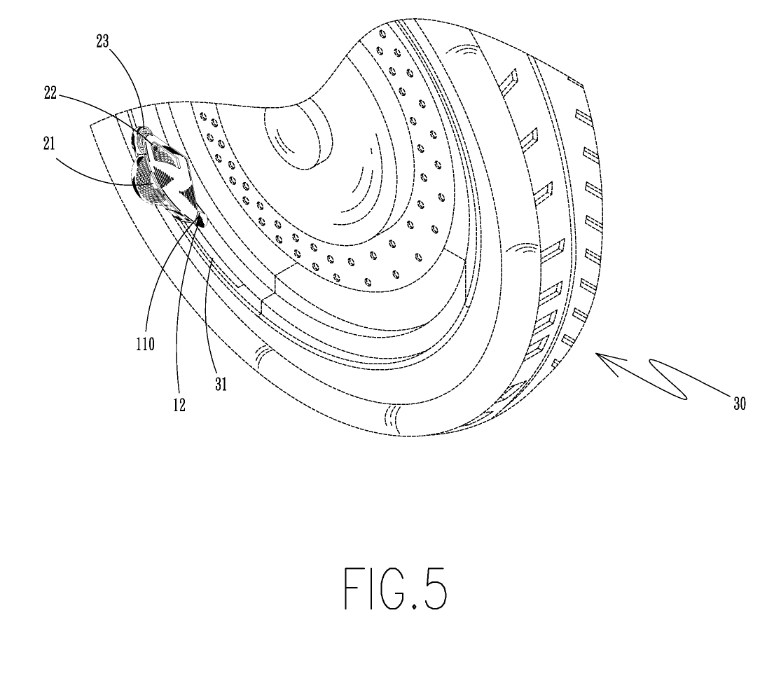

FIGS. 4 and 5 are cross-sectional and partial cross-sectional views schematically showing the practical use of the present invention. Wherein, the tape roll gear 21 is pivotally mounted on the first support shaft 13 of the casing 10; the elastic position-limited teeth 210 are engaged with the ratchet wheel 130 which is installed between the first support shaft 13 and the casing 10. The driven gear 22 is mounted on the protruded shaft 15 of the casing 10 pivotally, and the released paper rolling gear 23 is sheathed with the speed adjusting wheel 24 and pivotally mounted on the second support shaft 14 of the casing 10. The tape roll gear 21 is meshed with the driven gear 22; and the driven gear 22 is further meshed with the released paper rolling wheel 23 to transmit the driving. A sticker tape is winded around the tape roll gear 21 to form a tape roll comprising an adhesive layer and a released paper. The front end of the adhesive layer extends out of the dispensing outlet 11 of the casing 10, the pressure roller 111 where located at the dispensing outlet 11 of the casing 10 is pressed on the layer to provide a brake force; in addition, the elastic position-limited teeth 210 of the tape roll gear 21 are engaged with the ratchet wheel 130 in order to prevent the loosing of the tape roll gear 21. When the tape roll is dispensing and rotating together with the tape roll gear 21, the driven gear 22 and the released paper rolling wheel 23 will be rotated as well, so as the released paper of the tape can be retrieved with the released paper rolling wheel 23, as for the speed of retrieving is adjustable by adjusting the speed adjusting wheel 24 which sheathed with the released paper rolling wheel 23, so that a lock of the tape roll gear 21, driven gear 22 and the released paper rolling wheel 23 can be avoided, and the corrugated mark and the breaking of the adhesive layer will not be happened. Meanwhile, the pressure plate 12 of the casing 10 is used for guiding the sticker tape plastering along the edge of the wheel rim 31 of a tire 30. Thus, the usage of the light-reflectable tape is more convenient and the shape of the tape can be remained as well.

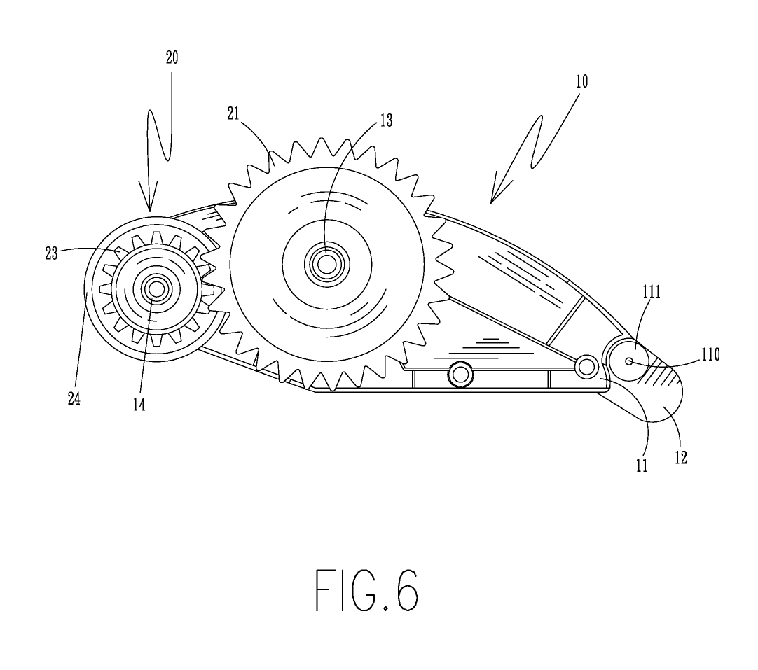

Referring to the FIG. 6 is a cross-sectional view schematically showing another embodiment of the present invention.

The transferring device comprises:

a casing 10, having an dispensing outlet 11, a pressure plate 12, a first support shaft 13 and a second support shaft 14; wherein, the pressure plate 12 is situated at the front end of the dispensing outlet 11, and two pivot centers 110 are situated at the opposite side of the dispensing outlet 11 provided for a pressure roller 111 to install on the pivot centers 110 pivotally; and

a gear transmission unit 20, comprising a tape roll gear 21 and a released paper rolling gear 23; wherein, the tape roll gear 21 is pivotally mounted on the first support shaft 13 of the casing 10; and the released paper rolling gear 23 is also mounted on the second support shaft 14 of the casing 10 pivotally. The tape roll gear 21 is meshed with the released paper rolling wheel 23, and the gear transmission unit 20 is provided in the casing 10. A sticker tape is winded around the tape roll gear 21 to form a tape roll comprising an adhesive layer and a released paper. The front end of the adhesive layer extends out of the dispensing outlet 11 of the casing 10, the pressure roller 111 where located at the dispensing outlet 11 of the casing 10 is pressed on the layer to provide a brake force; in addition, the released paper of the tape is retrieved with the released paper rolling wheel 23. Meanwhile, the pressure plate 12 of the casing 10 is used for guiding the sticker tape plastering along the edge of the wheel rim 31 of a tire 30. When the tape roll is dispensing and rotating together with the tape roll gear 21, the released paper rolling wheel 23 will be rotated as well, so as the released paper of the tape can be retrieved with the released paper rolling wheel 23. As a result, the corrugated mark and the breaking of the adhesive layer will not be happened during the operation of the device by means of the gear transmission unit 20. Thus, the usage of the light-reflectable tape is more convenient and the shape of the tape can be remained as well.

In the light of the above, the advantages of the present invention include:

1. Convenience of use: Due to the pressure plate 12 of the casing 10 is used for guiding the sticker tape plastering along the edge of the wheel rim 31 of a tire 30, and the tape is winded around the tape roll gear 21 of the gear transmission unit 20, when the tape roll is dispensing and rotating together with the tape roll gear 21, the driven gear 22 and the released paper rolling wheel 23 will be rotated as well, so as the released paper of the tape will be retrieved with the released paper rolling wheel 23. Thus, the use of the transferring device is convenience.

2. Maintenance of the shape: Due to the tape is winded around the tape roll gear 21 of the gear transmission unit 20, when the tape roll is dispensing and rotating together with the tape roll gear 21, the driven gear 22 and the released paper rolling wheel 23 will be rotated as well, so as the released paper of the tape will be retrieved with the released paper rolling wheel 23. As a result, the corrugated mark and the breaking of the adhesive layer will not be happened during the operation of the device by means of the gear transmission unit 20, thus the shape of the tape can be maintained.

Although numerous characteristics and advantages of the present invention have been described in detail in the foregoing description, together with the structure and function of the invention, this disclosure is only one of the examples, and changes may be made with regard to specific details, particularly to shape, size, and arrangement of parts within the invention to the full extent indicated by the general meaning of the terms in which the appended claims are expressed.

What is claimed is:

1. A transferring device, comprising:
a casing, having an dispensing outlet, a first support shaft, a second support shaft and a protruded shaft; wherein, two pivot centers are situated at the opposite side of the dispensing outlet provided for a pressure roller to install on the pivot centers pivotally; in addition, a ratchet wheel is installed between the first support shaft and the casing; and
a gear transmission unit, comprising a tape roll gear, a driven gear, a released paper rolling gear and a speed adjusting wheel; wherein, a plurality of elastic position-limited teeth are installed inside of the tape roll gear, and the tape roll gear is pivotally mounted on the first support shaft of the casing; the elastic position-limited teeth are engaged with the ratchet wheel which is installed between the first support shaft and the casing; the driven gear is mounted on the protruded shaft of the casing pivotally, and the released paper rolling gear is sheathed with the speed adjusting wheel and pivotally mounted on the second support shaft of the casing; the tape roll gear is meshed with the driven gear and the driven gear is further meshed with the released paper rolling wheel to transmit the driving; as for the gear transmission unit is provided in the casing.

2. A transferring device as claimed in claim 1, wherein a pressure plate is situated at the front end of the dispensing outlet.

3. A transferring device as claimed in claim 1, wherein a sticker tape is winded around the tape roll gear to form a tape roll comprising an adhesive layer and a released paper; the front end of the adhesive layer extends out of the dispensing outlet of the casing, the pressure roller where located at the dispensing outlet of the casing is pressed on the layer to provide a brake force; in addition, the elastic position-limited teeth of the tape roll gear are engaged with the ratchet wheel in order to prevent the loosing of the tape roll gear; when the tape roll is dispensing and rotating together with the tape roll gear, the driven gear and the released paper rolling wheel are rotated as well, so as the released paper of the tape is retrieved with the released paper rolling wheel; as for the speed of retrieving is adjustable by adjusting the speed adjusting wheel which sheathed with the released paper rolling wheel, so that a lock of the tape roll gear, driven gear and the released paper rolling wheel is avoided.

4. A transferring device, comprising:
a casing, having an dispensing outlet, a first support shaft and a second support shaft; wherein, two pivot centers are situated at the opposite side of the dispensing outlet provided for a pressure roller to install on the pivot centers pivotally; and
a gear transmission unit, comprising a tape roll gear, a released paper rolling gear and a speed adjusting wheel; wherein, a plurality of elastic position-limited teeth are installed inside of the tape roll gear, and the tape roll gear is pivotally mounted on the first support shaft of the casing; and the released paper rolling gear is pivotally mounted on the second support shaft of the casing; the tape roll gear is meshed with the released paper rolling wheel, and the gear transmission unit is provided in the casing.

5. A transferring device as claimed in claim 4, wherein a pressure plate is situated at the front end of the dispensing outlet.

6. A transferring device as claimed in claim 4, wherein a sticker tape is winded around the tape roll gear to form a tape roll comprising an adhesive layer and a released paper; the front end of the adhesive layer extends out of the dispensing outlet of the casing, the pressure roller where located at the dispensing outlet of the casing is pressed on the layer to provide a brake force; in addition, when the tape roll is dispensing and rotating together with the tape roll gear, the released paper rolling wheel is rotated as well, so as the released paper of the tape is retrieved with the released paper rolling wheel.
